(19) United States
(12) Patent Application Publication
(10) Pub. No.: US 2011/0027493 A1
(43) Pub. Date: Feb. 3, 2011

(54) METHODS OF SLIDE COATING FLUIDS CONTAINING MULTI UNIT POLYMERIC PRECURSORS

(76) Inventors: Robert A. Yapel, Oakdale, MN (US); Thomas J. Ludemann, Maplewood, MN (US); Daniel V. Norton, St. Paul, MN (US)

Correspondence Address: 3M INNOVATIVE PROPERTIES COMPANY, PO BOX 33427, ST. PAUL, MN, 55133-3427, US

(21) Appl. No.: 12/933,496

(22) PCT Filed: Mar. 24, 2009
(86) PCT No.: PCT/US09/38002

§ 371 Date: Sep. 20, 2010

Related U.S. Application Data
(63) Continuation of application No. 61/039,637, filed on Mar. 26, 2008.

(51) Int. Cl. C08F 2/48; C08F 2/54; B05D 3/12; C08F 2/46

(52) U.S. Cl. 427/496; 427/521; 427/346

(57) ABSTRACT

A method of slide coating that includes providing a first fluid (55), wherein the first fluid includes multi unit polymeric precursors; flowing the first fluid down a first slide surface, the first slide surface being positioned adjacent a substrate; coating the substrate (18) with the first fluid by flowing the first fluid from the first slide surface (53) to the substrate to form a first coated layer; moving the substrate; and curing the first coated layer.

### FIELD

The present disclosure relates to methods of slide coating fluids that include multi unit polymeric precursors.

### BACKGROUND

Slide coating is a method for coating one or more fluid layers on a substrate. The one or more fluids making up the layer precursors flow out of one or more slots that open out onto an inclined plane. The one or more fluids flow down the plane, across the coating gap and onto an upward moving substrate. A number of developments have been reported in this area, but the upper coating speed of slide coating has generally been dictated by the rheology of the polymer solutions that are coated onto the substrate.

### BRIEF SUMMARY

Disclosed herein are methods of slide coating that include providing a first fluid, wherein the first fluid includes multi unit polymeric precursors; flowing the first fluid down a first slide surface, the first slide surface being positioned adjacent a substrate; coating the substrate with the first fluid by flowing the first fluid from the first slide surface to the substrate; moving the substrate; and curing the first fluid.

Also disclosed herein are methods of slide coating that include providing a first fluid, wherein the first fluid includes multi unit polymeric precursors and single unit polymeric precursors; flowing the first fluid down a first slide surface, the first slide surface being positioned adjacent a substrate; coating the substrate with the first fluid by flowing the first fluid from the first slide surface to the substrate; moving the substrate; drying at least a portion of the first fluid; and curing the first fluid.

Also disclosed herein are methods of slide coating that include providing a first fluid, wherein the first fluid includes multi unit polymeric precursors, single unit polymeric precursors and one or more solvents; flowing the first fluid down a first slide surface, the first slide surface being positioned adjacent a substrate; moving the substrate past the first slide surface through use of a roll; coating the substrate with the first fluid by flowing the first fluid from the first slide surface to the substrate; drying the first fluid; and curing the first fluid.

### BRIEF DESCRIPTION OF THE DRAWINGS

The disclosure may be more completely understood in consideration of the following detailed description of various embodiments of the disclosure in connection with the accompanying drawings, in which:

The figures are not necessarily to scale. Like numbers used in the figures refer to like components. However, it will be understood that the use of a number to refer to a component in a given figure is not intended to limit the component in another figure labeled with the same number.

FIG. 1 is a side sectional view of a slide coater that can be used to carry out methods as disclosed herein;

FIG. 2 is a partial top view of the slide coater shown in FIG. 1;

FIG. 3 is a partial side sectional view of the slide coater show in FIG. 1;

FIG. 4 is a partial side sectional view of an embodiment of the slide coater shown in FIG. 1;

FIG. 5 is a partial side sectional view of an embodiment of the slide coater shown in FIG. 1;

FIG. 6 is a schematic view of an embodiment of the slide coater shown in FIG. 1 and additional components; and

FIG. 7 is a partial top view of an embodiment of the slide coater shown in FIG. 1.

### DETAILED DESCRIPTION

Embodiments other than those specifically discussed herein are contemplated and may be made without departing from the scope or spirit of the present disclosure. The following detailed description is not limiting. The definitions provided are to facilitate understanding of certain terms frequently used and do not limit the disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification, use of a singular form of a term, can encompass embodiments including more than one of such term, unless the content clearly dictates otherwise. For example, the phrase “adding a solvent” encompasses adding one solvent, or more than one solvent, unless the content clearly dictates otherwise. As used in this specification and the appended claims, the term “or” is generally employed in its sense including “either or both” unless the context clearly dictates otherwise.

“Include,” “including,” or like terms means encompassing but not limited to, that is, including and not exclusive.

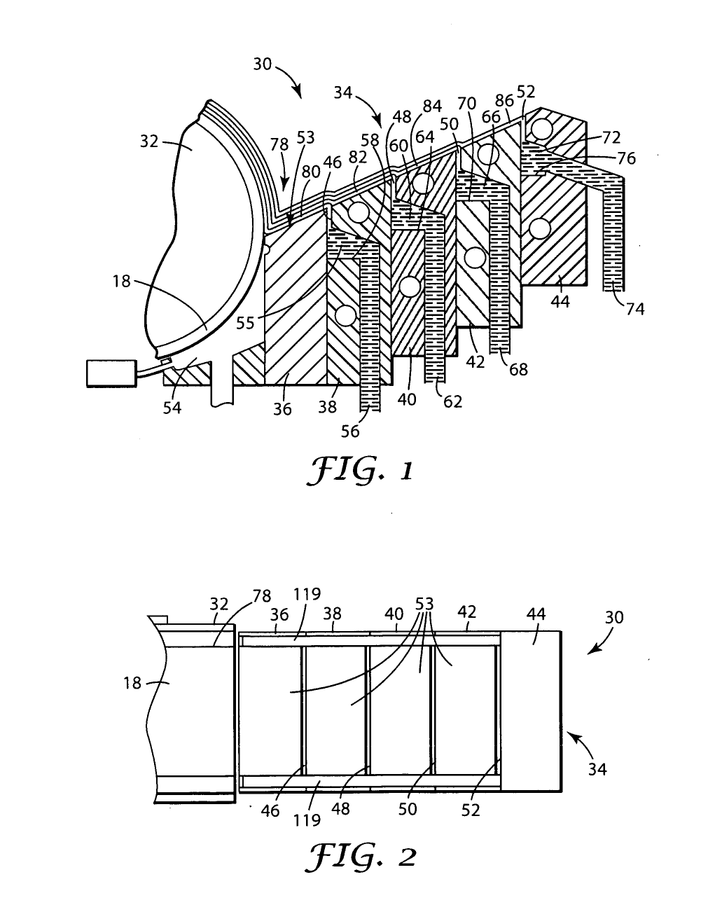

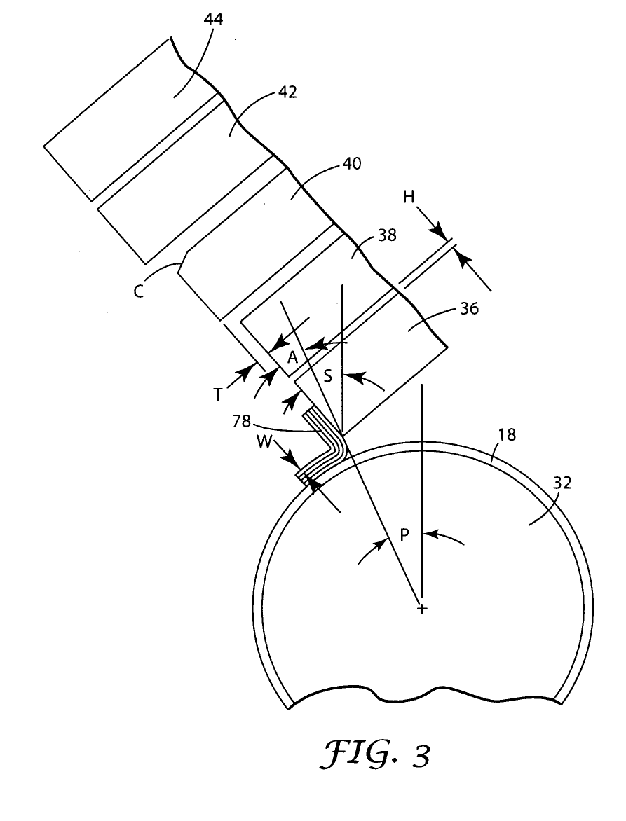

Disclosed herein are methods of slide coating. Methods disclosed herein can generally be carried out on slide coating apparatuses as are generally available and used in the art. FIGS. 1 and 2 illustrate a slide coating apparatus 30 generally including a coating back-up roller 32 for the substrate 18, and a slide coater 34. The slide coater 34 includes five slide blocks 36, 38, 40, 42, 44 which define four fluid slots 46, 48, 50, 52 and a slide surface 53.

The first slide block 36 is adjacent to the coating back-up roller 32 and includes a vacuum box 54 for adjusting the vacuum level of the slide coating apparatus 30. The vacuum box 54 serves to maintain a differential pressure across the coating bead, thereby stabilizing it.

A first fluid 55 can be distributed to the first slot 46 via a first fluid supply 56 and a first manifold 58. A second fluid 60 can be distributed to the second slot 48 via a second fluid supply 62 and a second manifold 64. A third fluid 66 can be distributed to the third fluid slot 50 via a third fluid supply 68 and a third fluid manifold 70. A fourth fluid 72 can be distributed to the fourth fluid slot 52 via a fourth fluid supply 74 and a fourth fluid manifold 76. This embodiment allows for the creation of up to a four-layer fluid construction 78 including a first fluid layer 80, a second fluid layer 82, a third fluid layer 84, and a fourth fluid layer 86. Additional slide blocks can be added for the introduction of additional fluid layers, as desired for product performance or ease of operability. Similarly, if less layers are to be coated, for example coating only two layers, slide blocks can be removed.

The fluid manifolds 58, 64, 70 and 76 are designed to allow uniform width-wise distribution from fluid slots 46, 48, 50, 52, respectively. This design is specific to the choice of slot height H (illustrated in FIG. 3) for the slots 46, 48, 50, 52. The slot height H is made sufficiently small such that the pressure drop in the slot is much higher than the pressure drop across the manifold (without causing undue problems of non-uniformity due to machining limitations or bar deflection due to excessive pressure in the die slot). This can aid in the fluid being distributed uniformly in the slot.

The slide blocks 38, 40, 42, 44 can be configured to have specific slot heights H as depicted in FIG. 3, chosen amongst other reasons to minimize pressure in the die manifolds and to overcome possible problems of non-uniformity due to machining limitations. The slot heights typically used range between about 100-1500 micrometers (μm). The slide blocks 38, 40, 42, 44 can also be arranged with a level offset so as to result in slot steps T, also depicted in FIG. 3. These steps can aid the uniform flow of fluid down the slide surface 53 by minimizing the possibility of flow separation and fluid recirculation zones that can lead to streaking and other product defects. These slot steps can range from about 0-2000 μm in height. Another method of minimizing the occurrence of flow separation on the slide surface 53 is by machining chamfers C on the downstream side of a fluid slot, as depicted in FIG. 3, and could also be used in the embodiment of slide coating as described herein.

In the machining of the slide blocks 36, 38, 40, 42, 44, the finish of the block edges that form the edges of the fluid slots 46, 48, 50, and 52 can be important, as is the front edge of the front block 36 that is adjacent to backup roller 32. The presence of nicks, burrs or other defects on these edges can lead to streaking defects in the product. In order to avoid such defects, the edges can be polished to a finish of less than about 8 microinches (0.02 μm). Details regarding the procedure for finishing the die edges are disclosed in commonly assigned U.S. Pat. No. 5,851,137 and U.S. Pat. No. 5,655,948.

FIG. 3 also illustrates the orientation of the slide coater 34 relative to the back-up roller 32, including the position angle P, attack angle A, and the slide angle S. (The slide angle S is the sum of the position angle P and the attack angle A.) A negative position angle P can generally allow for increased wrap on the back-up roller and thereby greater stability for the coating operation. However, the method could also be used with a zero or positive position angle. The slide angle S at least partially determines the stability of the flow of fluids down the inclined slide plane. A large slide angle S can lead to the development of surface wave instabilities and consequently coating defects. The slide angle can typically be set in the range from slightly greater than zero to about 45°. The distance between the slide coater 34 and the roller 32 at the point of closest approach is known as the coating gap G. The wet thickness W of each layer is the thickness on the surface of the coated substrate 18 substantially far away from the coated bead, but close enough before appreciable drying has occurred.

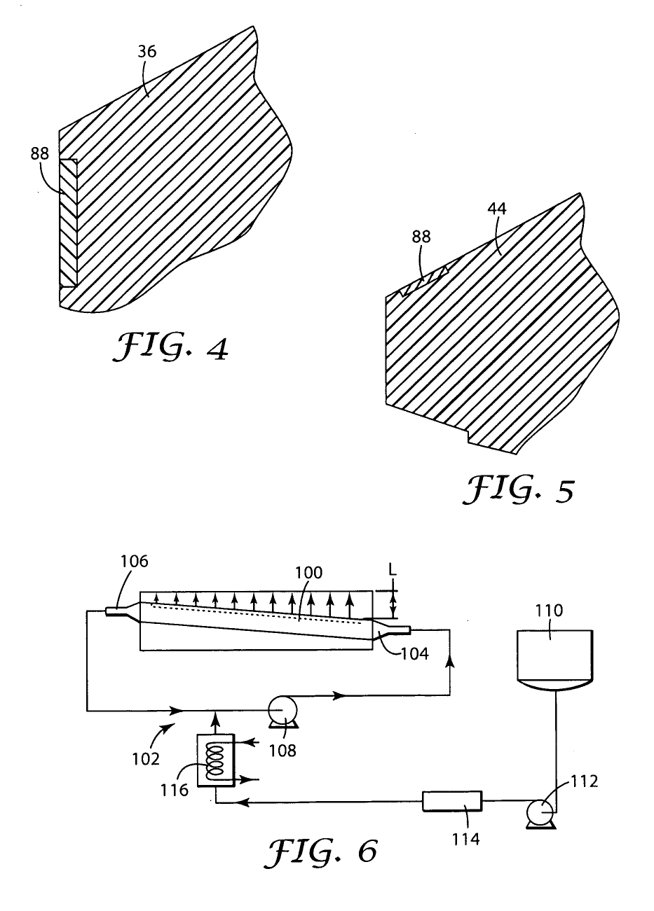

Other portions of the slide coating apparatus 30 deserve further discussion. FIGS. 4 and 5 illustrate portions of the slide coater which include durable, low surface energy portions 88. These portions 88 can provide the desired surface energy properties to specific locations to uniformly pin the coating fluid to prevent build-up of dried material. Details regarding one process of making the durable, low surface energy portions 88 are disclosed in commonly assigned U.S. Pat. No. 5,998,549.

FIG. 6 illustrates a particular type of end-fed manifold 100 and a recirculation loop 102. Note that the manifold 100 is shown as being inclined towards the outlet port 106 such that the depth of the slot L decreases from the inlet port 104 to the outlet port 106. The incline angle can be carefully adjusted to take into account the pressure drop in the fluid as it traverses from the inlet port 104 of the manifold 100 to the outlet port 106 to ensure that the width-wise fluid distribution at the exit of the slot is uniform. With the illustrated manifold design, only a portion of the fluid that enters the manifold 100 leaves through the fluid slot (such as slots 46, 48, 50, or 52), while the remainder flows out through the outlet port 106 to the recirculation loop 102. The portion which flows through the outlet port 106 can be recirculated back to the inlet port 104 by a recirculation pump 108. The recirculation pump 108 can receive fresh fluid from a fluid reservoir 110 and fresh fluid pump 112. A fluid filter 114 and/or heat exchanger 116 can be included to filter and/or heat or cool the fresh fluid before it mixes with the recycled fluid. In this case, the same principles that apply to the design of end-fed manifolds are still applicable. The manifold design, i.e., the cavity shape and angle of incline, however, depends not only on the choice of slot height and fluid rheology, but on the percent recirculation used.

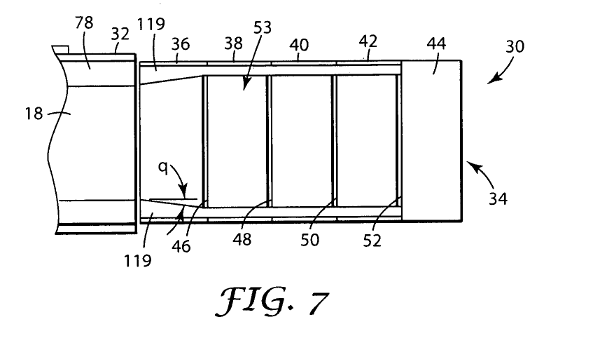

The flow of fluid down the slide surface 53 can be aided by the use of edge guides 119 at each edge of the surface, as shown in FIG. 2 (and FIG. 7). The edge guides 119 can serve to pin the solution to the solid surface and result in a fixed width of coating and also stabilize the flow of fluid at the edges. Note that the edge guides can be straight, and direct flow perpendicular to the slots 46, 48, 50, 52 over the slide surface. The edge guides 119 can be made of one material including metals such as steel, aluminum, etc.; polymers such as polytetrafluoroethylene (e.g., TEFLON®), polyamide (e.g., Nylon), poly(methylene oxide) or polyacetal (e.g., DELRIN®), etc.; wood; ceramic, etc., or can be made of more than one material such as steel coated with polytetrafluoroethylene.

The edge guides 119A can be of a convergent type, as illustrated in FIG. 7. The angle of convergence q can be between about 0 degrees and about 90 degrees, with 0 degrees corresponding to the case of the straight edge guides shown in FIG. 2. The angle q can be chosen for increased stability of the coating bead edges by increasing coating thickness at the bead edges relative to the center. In other embodiments, the edge guides can include durable, low surface energy surfaces or portions as described previously. In addition, the edge guides can be profiled to match the fluid depth profile on the slide surface as described in commonly assigned U.S. Pat. No. 5,837,324.

A cover or shroud over the slide coater 34 can also be used (not shown). An example of such a cover or shroud is described in detail in commonly assigned U.S. Pat. No. 5,725,665.

Methods as disclosed herein generally include steps of providing a first fluid, flowing the first fluid down a first slide surface, the first slide surface being positioned adjacent a substrate, coating the substrate with the first fluid by flowing the first fluid from the first slide surface to the substrate, moving the substrate and curing the first fluid.

The first step in methods as disclosed herein includes providing a first fluid. The step of providing a first fluid can be accomplished by obtaining an already prepared first fluid or by preparing a first fluid. Any methods known to one of skill in the art to prepare a solution can be utilized to prepare the first fluid.

The first fluid includes multi unit polymeric precursors. A multi unit polymeric precursor is a molecule that once cured, becomes a polymer. A multi unit polymeric precursor can be distinguished from a polymer because a multi unit polymeric precursor still contains reactive groups that can be polymerized. Oligomers, as that term is commonly used can be considered multi unit polymeric precursors. A multi unit polymeric precursor generally includes two or more repeating units of the eventual polymer that is formed there from. In an embodiment, a multi unit polymeric precursor has a number average molecular weight (Mn) of less than about 10,000 g/mol. In one embodiment, a multi unit polymeric precursor has a number average molecular weigh of less than about 8000 g/mol. In one embodiment, a multi unit polymeric precursor has a number average molecular weight of less than about 6000 g/mol. In one embodiment, a multi unit polymeric precursor has a number average molecular weight of less than about 2000 g/mol. In one embodiment, a multi unit polymeric precursor has a number average molecular weight of about 1000 g/mol.

Any multi unit polymeric precursors can be utilized as a component of the first fluid. In an embodiment, more than one kind of multi unit polymeric precursor can be included in the first fluid. In an embodiment, multi unit polymeric precursors that are acrylates can be utilized. In an embodiment, epoxy acrylates, urethane acrylates, carboxylic acid half esters, polyester acrylates, acrylated acrylics, or combinations thereof can be utilized as multi unit polymeric precursors. In an embodiment, urethane acrylates can be utilized as multi unit polymeric precursors in the first fluid.

Examples of commercially available multi unit polymeric precursors that can be utilized include those available from Sartomer Company, Inc. (Exton, Pa.) and the PHOTOMER® and BISOMER® line of products available from Cognis Corporation (Cincinnati, Ohio). Specific compounds include, but are not limited to, Photomer® 6010 aliphatic urethane diacrylate (Cognis Corporation, Cincinnati, Ohio); Photomer® 6210 aliphatic urethane diacrylate (Cognis Corporation, Cincinnati, Ohio); CN 301 polybutadiene dimethacrylate (Sartomer, Exton, Pa.); CN 964 aliphatic polyester based urethane diacrylate (Sartomer, Exton, Pa.); CN 966 aliphatic polyester based urethane diacrylate (Sartomer, Exton, Pa.); CN 981 aliphatic polyester/polyether based urethane diacrylate (Sartomer, Exton, Pa.); CN 982 aliphatic polyester/polyether based urethane diacrylate (Sartomer, Exton, Pa.); CN 985 aliphatic urethane diacrylate (Sartomer, Exton, Pa.); CN 991 aliphatic polyester based urethane diacrylate (Sartomer, Exton, Pa.); CN 9004 difunctional aliphatic urethane acrylate (Sartomer, Exton, Pa.); and combinations thereof for example.

The particular multi unit polymeric precursor or precursors included in any fluid utilized herein can depend at least in part on the ultimate article that is being made. For example, the particular multi unit polymeric precursor may be chosen because, once cured, it provides enhanced weatherability, enhanced scratch resistance, or other similarly desirable properties. The particular multi unit polymeric precursor or precursors that will be utilized in any fluid utilized herein can also depend at least in part on the substrate on which the first fluid is being coated. For example, the particular multi unit polymeric precursor may be chosen because it adheres well with the particular substrate being used.

The first fluid may also include other components in addition to the multi unit polymeric precursors. Examples of such other optional components include, but are not limited to single unit polymeric precursors, one or more solvents, optical enhancement additives, initiators, and other additives.

The first fluid may optionally include single unit polymeric precursors. A single unit polymeric precursor is a molecule that once cured, becomes a multi unit polymeric precursor or a polymer. A single unit polymeric precursor includes only one unit that is repeated in the polymer that it forms once cured. A single unit polymeric precursor can be distinguished from a multi unit polymeric precursor because a multi unit polymeric precursor has two or more units that are repeated in the polymer that it forms once cured. Monomers, as that term is commonly used can be considered single unit polymeric precursors.

In embodiments where the first fluid includes single unit polymeric precursors, the single unit polymer precursor can be similar to or different than the multi unit polymeric precursor. In an embodiment, more than one kind of single unit polymeric precursors can be included in the first fluid. In an embodiment, single unit polymeric precursors that are acrylates can be utilized. In an embodiment, monofunctional, difunctional, trifunctional, tetrafunctional, higher functionality acrylate monomers, or combinations thereof can be utilized.

Examples of commercially available single unit polymeric precursors that can be utilized include those available from Sartomer Company, Inc. (Exton, Pa.). Specific compounds include, but are not limited to, SR238 1,6 hexanediol diacrylate monomer (Sartomer Company, Inc., Exton, Pa.); SR 355 ditrimethylolpropane tetraacrylate (Sartomer, Exton, Pa.); SR 9003 propoxylated neopentyl glycol diacrylate (Sartomer, Exton, Pa.); SR 506 isobornyl acrylate (Sartomer, Exton, Pa.); Bisomer HEA 2-hydroxy ethyl acrylate (Cognis Corporation, Cincinnati, Ohio); and combinations thereof for example.

The particular single unit polymeric precursor or precursors that can optionally be included in any fluid utilized herein can depend at least in part on the ultimate article that is being made. For example, the particular single unit polymeric precursor may be chosen because it enhances the crosslinking of the multi unit polymeric precursor, thereby affecting the ultimate physical properties of the cured layer. Similarly, the particular single unit polymeric precursor may be chosen because it increases the rate at which the multi unit polymeric precursor crosslinks, thereby allowing the entire coating process to be carried out faster.

In an embodiment, the amount of multi unit polymeric precursor and the amount (if any) of single unit polymeric precursor can affect both the ability to coat the first fluid and the properties of the ultimate coated article. It is thought, but not relied upon that the multi unit polymeric precursors and/or the amount of the multi unit polymeric precursors generally determine at least in part, the ultimate physical properties of the article that is being made; and the single unit polymeric precursors and/or the amount of the single unit polymeric precursors determine at least in part, the rate of crosslinking of the coated layer.

The first fluid may optionally include at least one solvent. In an embodiment, the at least one solvent is an organic solvent. Generally, the at least one solvent is chosen to be compatible with the multi unit polymeric precursor and any other optional components of the first fluid. The at least one solvent may also be chosen based, at least in part, on the ease of drying a coated layer containing the solvent. One of skill in the art, given the particular multi unit polymeric precursor (and any other optional components that are included in the first fluid) that is being utilized can generally determine appropriate solvents to be included. The at least one solvent, if included can be a solvent that is in solution with another one of the components (for example, the multi unit polymeric precursor or the single unit polymeric precursor if included), can be added separately, or a combination thereof (in which case the solvent can be the same solvent or a different solvent).

Exemplary solvents that can be utilized herein include organic solvents, such as ethyl acetate, propylene glycol methyl ether (commercially available as DOWANOL™ PM from the Dow Chemical Company, Inc., Midland, Mich.), toluene, isopropyl alcohol (IPA), methyl ethyl ketone (MEK), dioxolane, ethanol, and combinations thereof for example. In an embodiment, the second fluid does not contain any more than 10% by weight of water. In an embodiment, the first fluid does not contain any more than 1% by weight of water. In an embodiment, the first fluid is substantially free of water.

The first fluid may also optionally include optical enhancement additives. Optical enhancement additives are generally components that can either make the coating better, thereby creating an optically better product, or can change the optical properties of the coating. One such optical enhancement additive is beads. Beads, for example, can be utilized to provide the coated layer with a matte surface. In an embodiment, the first fluid may optionally include polymeric beads, such as acrylic beads. Examples of polymeric beads that can optionally be utilized herein include acrylic beads, such as polymethyl methacrylate beads commercially available under the trade name MX available from Soken Chemical & Engineering Co., Ltd., Tokyo, Japan; MBX from Sekisui Chemical Co. Ltd; and LDX series from Sunjin Chemical Company (Korea); acrylic beads from Esprix (Sarasota, Fla.); or combinations thereof, for example. In an embodiment, the second fluid may optionally include nanoparticles, such as titanium dioxide or silica nanoparticles for example.

The first fluid may also optionally include at least one initiator. Initiators that can be useful include both free-radical thermal initiators and/or photoinitiators. Useful free-radical thermal initiators include azo compounds, peroxide compounds, persulfate compounds, redox initiators, and combinations thereof for example. Useful free-radical photoinitiators include those known as useful in UV curing of acrylate polymers for example. Such initiators include products marketed under the trade name ESACURE® (Lamberti S.p.A., Gallarate (VA) Italy) for example. Combinations of two or more photoinitiators may also be used. Further, sensitizers such as 2-isopropyl thioxanthone, commercially available from First Chemical Corporation, Pascagoula, Miss., may be used in conjunction with photoinitiator(s).

Other optional enhancement additives or other general additives as would be known to one of skill in the art can also be included in the first fluid. An example of such other optional components include surfactants, such as fluorosurfactants for example. Another example of such optional components include slip agents that function to influence the coefficient of friction; an example of a slip agent that could be used is silicone polyether acrylate (i.e., TegoRad 2250, Goldschmidt Chemical Co., Janesville, Wis.) for example.

One of skill in the art will understand that the amount of multi unit polymeric precursors present in the first fluid can depend at least in part on the identity of the multi unit polymeric precursor, the inclusion and identity of optional components that may also be included in the first fluid and the ultimate application and desired properties of the coated article. The first fluid can generally include up to about 10% by weight (based on the total weight of the first fluid before coating) of multi unit polymeric precursors. In an embodiment, the first fluid can generally include up to about 5% by weight (based on the total weight of the first fluid before coating) of multi unit polymeric precursors. In an embodiment, the first fluid can generally include from about 2% to about 3% by weight (based on the total weight of the first fluid before coating) of multi unit polymeric precursors.

In embodiments where the first fluid includes optional single unit polymeric precursors, the amount of single unit polymeric precursors present in the first fluid can depend at least in part on the identity of the single unit polymeric precursor, the inclusion and identity of other optional components and the multi unit polymeric precursors and the ultimate application and desired properties of the coated article. The first fluid can generally include up to about 90% by weight (based on the total weight of the first fluid before coating) of single unit polymeric precursors. In an embodiment, the first fluid can generally include up to about 50% by weight (based on the total weight of the first fluid before coating) of single unit polymeric precursors. In an embodiment, the first fluid can generally include from about 20% to about 25% by weight (based on the total weight of the first fluid before coating) of single unit polymeric precursors.

In embodiments where the first fluid optionally includes at least one solvent, the amount of solvent present in the first fluid can depend at least in part on the identity of the solvent, the inclusion and identity of other optional components and the multi unit polymeric precursors, the ultimate application and desired properties of the coated article and requirements for drying. The first fluid can generally include up to about 99.5% by weight (based on the total weight of the first fluid before coating) of at least one solvent. In an embodiment, the first fluid can generally include up to about 50% by weight (based on the total weight of the first fluid before coating) of at least one solvent. In an embodiment, the first fluid can generally include from about 15% to about 20% by weight (based on the total weight of the first fluid before coating) of at least one solvent.

Other optional components that can be added to the first fluid, such as those discussed above, can be added in amounts as would be known to one of skill in the art based on the identities of the optional components and the reasons why they are being added (i.e. the final desired properties that they are intended to obtain). In an embodiment where beads are added to the first fluid, they are generally present in the first fluid from about 0.02% to about 40% by weight (based on the total weight of the first fluid before coating). Some of the optional components that may be added to the first fluid may be polymeric in nature (for example, surfactants). However, exemplary first fluids, as utilized herein generally do not contain more than 5% by weight (based on the total weight of the first fluid before coating) of a polymeric component. It should be noted that beads, even if the beads are polymeric beads, are not included in this lower limit of polymeric components. In embodiments that do not contain any polymeric optional components, the first fluid is generally substantially free of polymer before it is cured. It should be noted that any polymeric components in the first fluid are not necessary to coat the first fluid and are generally only added to affect other properties.

In an exemplary embodiment, a first fluid generally includes at least multi unit polymeric precursors, single unit polymeric precursors and at least one solvent. In an exemplary embodiment, a first fluid generally includes at least multi unit polymeric precursors, single unit polymeric precursors, at least one solvent and at least one initiator, for example, a photoinitiator. In an exemplary embodiment, a first fluid generally includes at least multi unit polymeric precursors, single unit polymeric precursors, at least one solvent, at least one initiator, and polymeric beads.

In an embodiment, a first fluid has a viscosity that enables it to be slide coated onto a substrate. Generally, the viscosity of the first fluid is a compromise between the ability to coat the fluid (lower viscosity fluid is generally easier to coat) and the desire to obtain a mottle free surface of the coated layer. In an embodiment, the viscosity of the first fluid is not greater than about 10 centipoise (cps). In an embodiment, the viscosity of the first fluid is not greater than about 5 cps. In an embodiment, the viscosity of the first fluid is not greater than about 2 cps. The viscosity of the first fluid is determined, at least in part, by the viscosity of the multi unit polymeric precursor and the amount of the multi unit polymeric precursor in the first fluid. The viscosity of the first fluid can be decreased by either using less of a particular multi unit polymeric precursor or by using a multi unit polymeric precursor with a lower viscosity or a combination thereof.

In embodiments that utilize first fluids including optional components such as single unit polymeric precursors, the viscosity of the first fluid can be determined, at least in part, based on the viscosity of the single unit polymeric precursor and/or the amount of the single unit polymeric precursor in the first fluid. The viscosity of the first fluid can be decreased by either using less of a particular single unit polymeric precursor or by using a single unit polymeric precursor with a lower viscosity or a combination thereof.

The viscosity of a first fluid can also be affected by solvent that may be included in the first fluid. Solvent, when included in the first fluid can have a significant effect on the viscosity of the first fluid. Generally, as the amount of solvent in the first fluid increases, the viscosity of the first fluid generally decreases. Similarly, as solvents with lower viscosity are utilized, the viscosity of the first fluid decreases. The viscosity can also be affected by other optional additives that may be included in the first fluid. One of skill in the art would know how such optional additives could affect the viscosity of the fluid and would be able to choose amounts and identities of components to obtain the desired viscosity.

The viscosity of the first fluid affects the coating methods and the set up of the apparatus that carries out the coating. For example, as the viscosity of the first fluid decreases, the first fluid can generally be coated at smaller thicknesses and/or can be coated at faster line speeds while still maintaining a visually acceptable coating. Conversely, as the viscosity of the first fluid increases, the first fluid generally has to be coated at larger thicknesses and/or be coated at slower line speeds in order to maintain a visually acceptable coating.

Methods as disclosed herein also include a step of flowing the first fluid down a first slide surface. As discussed above with respect to slide coating apparatuses that can be utilized in methods disclosed herein, a first fluid is distributed to a first slot via a first fluid supply and a first manifold, after which the first fluid exits the slot and is flowed down the first slide surface. Also as discussed above, this can generally be accomplished through the design and construction of the slide coating apparatus itself. The first slide surface is generally positioned adjacent a substrate. The configuration of the first slide surface with respect to the substrate is exemplified in FIG. 1. The rate of and the quantity of the first fluid that is flowed down the first slide surface is dictated at least in part by the slot height, H, of the first slot; the viscosity of the first fluid; and the desired coating thickness that is to be obtained on the substrate.

Methods as disclosed herein also include a step of coating the substrate with the first fluid by flowing the first fluid from the first slide surface to the substrate. As discussed above, the first slide surface is generally positioned adjacent the substrate, and the first fluid flows from the first slide surface across the coating gap to the substrate in order to form a layer of the first fluid on the substrate. The layer of the first fluid on the substrate can generally be referred to as the first coated layer.

Generally, slide coating methods involve a trade off between the viscosity of the first fluid and the coating gap of the slide coating apparatus. It is generally desired to utilize a larger coating gap during a coating process because it can make the coating process smoother and result in coatings having desired properties (such as acceptable visual appearance, etc.). Generally, as the viscosity is increased, the coating gap has to be made smaller in order to coat visually acceptable layers; and conversely, coating a fluid with a lower viscosity can be carried out with a larger coating gap. Generally, coating methods as disclosed herein can coat using larger coating gaps at higher line speeds than can other coating methods, such as for example, slot die coating. Generally, methods as disclosed herein can coat fluids using coating gaps of about 2 mils or greater (0.002 inches or 50 μm).

A coated layer formed from methods disclosed herein can generally be characterized by the wet thickness of the layer, referred to as Tw. The wet thickness of a coated layer is the thickness of the first fluid on the substrate at a point on the substrate substantially far away from the coated bead but close enough before appreciable drying has occurred. In an embodiment, the wet thickness can be measured on the substrate about 10 cm away from the coated bead.

Generally, slide coating methods involve a trade off between the minimum wet thickness of the coated layer that can still result in a visually acceptable coating (free of strikethrough and other similar defects) and the speed at which the coating can be carried out. Generally, methods as disclosed herein can be used to coat wet thicknesses as are commonly coated using slide coating methods. Slide coating methods as disclosed herein can generally coat lower minimum wet thicknesses at higher line speeds than other coating methods (such as for example, slot die coating). Generally, lower wet thicknesses can be advantageous because they can be dried quicker with less cosmetic defects such as mottle. In an embodiment, methods as disclosed herein can be utilized to coat wet thicknesses of about 6 μm or greater. In an embodiment, methods as disclosed herein can be utilized to coat wet thicknesses of about 10 μm or greater. In an embodiment, methods as disclosed herein can be utilized to coat wet thicknesses of about 15 μm or less even at line speeds of about 1000 feet per minute (5.08 meters per second).

Methods as disclosed herein also include a step of moving the substrate. In an embodiment, the substrate is moved through the use of a coating backup roller (an example of which can be seen in FIG. 1). Generally, the backup roller brings the substrate adjacent to the first slide surface, where it is coated with the first fluid, and then carries the coated substrate away from the first slide surface. The backup roller is generally configured within the slide coating apparatus in order to carry the coated substrate away from the first slide surface in order to allow further step(s) of the method to be carried out. Generally, methods as disclosed herein can include moving the substrate past the first slide surface (to be coated) at speeds (referred to herein as line speeds) as generally utilized in slide coating. In an embodiment, methods as disclosed herein can include utilizing line speeds of about 100 feet per minute (0.508 meters per second) or greater while still obtaining a visually acceptable coating. In an embodiment, methods as disclosed herein can include utilizing line speeds of about 200 feet per minute (1.016 meters per second) or greater while still obtaining a visually acceptable coating. In an embodiment, methods as disclosed herein can include utilizing line speeds of about 1000 feet per minute (5.08 meters per second) or greater while still obtaining a visually acceptable coating.

Methods as disclosed herein can be utilized to coat any substrates commonly or desired to be coated with known coating methods. Examples include polyethylene (PET) films, polyester films, polypropylene, triacetate cellulose (TAC), paper and polycarbonate for example. The choice of substrate can be made, at least in part, based on the final application and the final desired properties of the article.

Methods as disclosed herein also include a step of curing the coated layer. Curing the coated layer can include partial curing of the first fluid or complete curing of the first fluid. Curing can be accomplished as is commonly known to one of skill in the art, including utilizing a source of ultraviolet radiation, a source of infrared radiation, a source of x-rays, a source of gamma-rays, a source of visible light, a source of microwaves, an electron beam source, heat, or combinations thereof for example. In embodiments that include curing though the use of heat, an oven capable of thermally curing the first fluid can be utilized.

The method can also optionally include a step of drying at least a portion of the first fluid on the substrate before it is cured. The step of drying the first fluid generally includes evaporation of at least a portion of the solvent that may be present within the first fluid. The step of drying need not, but can evaporate all of the solvent that is present in the first fluid once coated. Drying can be accomplished based entirely on the ambient conditions that are present where the coating method is taking place, or can be controlled (either hastened or slowed down) by controlling the conditions of drying. For example, the temperature can be increased through the use of a drying oven in order to hasten the drying of the first fluid. Similarly, other environmental conditions can also be affected to hasten and/or control the drying of the first fluid. Such drying conditions are known to those of skill in the art. The step of drying can also continue during the curing step.

An exemplary method as disclosed herein includes providing a first fluid, wherein the first fluid includes multi unit polymeric precursors and single unit polymeric precursors; flowing the first fluid down a first slide surface, the first slide surface being positioned adjacent a substrate; coating the substrate with the first fluid by flowing the first fluid from the first slide surface to the substrate; moving the substrate; drying at least a portion of the first fluid; and curing the first fluid.

Another exemplary method as disclosed herein includes providing a first fluid, wherein the first fluid comprises multi unit polymeric precursors, single unit polymeric precursors and one or more solvents; flowing the first fluid down a first slide surface, the first slide surface being positioned adjacent a substrate; moving the substrate past the first slide surface through use of a roll; coating the substrate with the first fluid by flowing the first fluid from the first slide surface to the substrate; drying the first fluid; and curing the first fluid.

Methods as disclosed herein can also include coating subsequent layers on top of the first coated layer. One of skill in the art will know, having read this specification, how to carry out the coating of such subsequent layers. The subsequent fluids that are to be coated may be similar to, or different from the first fluid.

### EXAMPLES

A series of trials were run to determine the minimum wet thickness that could be coated while obtaining good coating quality at various coating gaps and line speeds. The fluid that was coated included 2.5% by weight of Photomer® 6210 oligomer (Cognis Corporation, Cincinnati, Ohio), 17.0% by weight of SR238 1,6 hexanediol diacrylate monomer (Sartomer Company, Inc., Exton, Pa.), 5.0% by weight of SR355 ditrimethylolpropane tetraacrylate monomer (Sartomer Company, Inc., Exton, Pa.), 0.25% by weight of Esacure One (Lamberti S.p.A., Gallarate (VA) Italy), 0.25% by weight of 3M™ NOVEC™ Fluorosurfactant FC-4432 (3M Company, Inc. St. Paul, Minn.), 0.67% by weight of MX 300 crosslinking acrylic beads (Polymethyl methacrylate—particle size 3.0±0.5 μm, refractive index 1.50) (Soken Chemical & Engineering Co., Ltd., Tokyo, Japan), and 74.33% by weight of methyl ethyl ketone (MEK). The viscosity of the fluid was measured to be 1.3 cps.

An experimental slide coater having a square nose front lip and 20 degree convergence edge guides was set with an attack angle of 25 degrees, a position angle of −10 degrees, a slot height of 250 μm and a step height of 200 μm. The solution above was coated onto a 2 mil MELINEX® 617 PET film (DuPont Teijin Films U.S. Limited Partnership, Hopewell, Va.).

The effectiveness of coating methods can be characterized by determining the minimum wet thickness (Tw) at a particular coating gap and coating speed. The coating gap divided by wet thickness is often used as a measure of performance. Table I below compares this slide coating experiment to a slot die coater. The data shows that the performance has a slower decrease with increasing coating speed for slide coating as compared to a slot die coating method. Ratios of gap to thickness that are higher are generally considered better.

TABLE I

| | | Coating | | | |
|---|---|---|---|---|---|
| Speed | Vacuum | gap | Tw | | Slot Die |
| (m/sec) | (mm H₂O) | (μm) | (μm) | Gap/Tw | Gap/Tw |
| 0.51 | 12.7 | 126 | 8.5 | 14.8 | 18.1 |
| 0.51 | 12.7 | 151 | 9.3 | 16.2 | |
| 0.51 | 12.7 | 176 | 10.7 | 16.4 | |
| 1.02 | 20.3 | 126 | 9.3 | 13.5 | 11.8 |
| 1.02 | 20.3 | 151 | 10.9 | 13.9 | |
| 1.02 | 20.3 | 176 | 15.5 | 11.4 | |
| 1.52 | 30.5 | 101 | 9.5 | 10.6 | |
| 1.52 | 30.5 | 126 | 10.4 | 12.1 | 9.2 |
| 1.52 | 20.3 | 151 | 14.5 | 10.4 | |
| 2.03 | 33.0 | 101 | 9.9 | 10.2 | |
| 2.03 | 22.9 | 126 | 12.7 | 9.9 | 7.8 |
| 2.03 | 20.3 | 151 | 15.5 | 9.7 | |
| 2.54 | 38.1 | 101 | 10.2 | 9.9 | |
| 2.54 | 33.0 | 126 | 11.4 | 11.1 | |
| 2.54 | 25.4 | 151 | 12.2 | 12.4 | |
| 3.05 | 30.5 | 101 | 11.6 | 8.7 | |
| 3.05 | 30.5 | 126 | 11.0 | 11.5 | |
| 3.05 | 20.3 | 151 | 12.9 | 11.7 | |
| 3.56 | 30.5 | 126 | 10.8 | 11.7 | |
| 3.56 | 30.5 | 151 | 11.5 | 13.1 | |
| 4.06 | 22.9 | 126 | 12.1 | 10.4 | |
| 4.06 | 22.9 | 151 | 12.4 | 12.2 | |
| 4.06 | 22.9 | 176 | 12.7 | 13.8 | |

Thus, embodiments of methods of slide coating fluids containing multi unit polymeric precursors are disclosed. One skilled in the art will appreciate that the present disclosure can be practiced with embodiments other than those disclosed. The disclosed embodiments are presented for purposes of illustration and not limitation.

1. A method of slide coating comprising:
providing a first fluid, wherein the first fluid comprises multi unit polymeric precursors;
flowing the first fluid down a first slide surface, the first slide surface being positioned adjacent a substrate;
coating the substrate with the first fluid by flowing the first fluid from the first slide surface to the substrate to form a first coated layer;
moving the substrate; and
curing the first coated layer.

2. The method according to claim 1, wherein the first fluid further comprises single unit polymeric precursors.

3. The method according to claim 1, wherein the first fluid further comprises one or more solvents.

4. The method according to claim 1, wherein the first fluid comprises not greater than about 10% by weight of water.

5. The method according to claim 1, wherein the multi unit polymeric precursors are acrylates.

6. The method according to claim 5, wherein the multi unit polymeric precursors are epoxy acrylates, urethane acrylates, carboxylic acid half esters, polyester acrylates, acrylated acrylics, or combinations thereof.

7. The method according to claim 1, wherein the viscosity of the first fluid is not greater than about 5 centipoise.

8. The method according to claim 1, wherein the first fluid further comprises beads.

9. The method according to claim 1, wherein the first fluid does not have more than about 5% by weight based on total weight of the first fluid before coating of polymer.

10. The method according to claim 1, wherein the first fluid is coated onto the substrate at a thickness of about 6 microns or thicker.

11. The method according to claim 1, further comprising drying at least a portion of the first fluid on the substrate before it is cured.

12. The method according to claim 1, wherein curing is accomplished using a source of ultraviolet radiation, a source of infrared radiation, a source of x-rays, a source of gamma-rays, a source of visible light, a source of microwaves, an electron beam source, heat, or combinations thereof.

13. The method according to claim 1, wherein the substrate is moved at a speed of at least about 0.5 meters per second.

14. The method according to claim 1, wherein there is a gap between the substrate and the first slide surface that is about 4 mils or greater.

15. A method of slide coating comprising:
providing a first fluid, wherein the first fluid comprises multi unit polymeric precursors and single unit polymeric precursors;
flowing the first fluid down a first slide surface, the first slide surface being positioned adjacent a substrate;
coating the substrate with the first fluid by flowing the first fluid from the first slide surface to the substrate to form a first coated layer;
moving the substrate;
drying at least a portion of the first fluid; and
curing the first coated layer.

16. The method according to claim 15, wherein the first fluid further comprises at least one solvent.

17. The method according to claim 15, wherein the first fluid comprises not greater than about 10% by weight of water.

18. The method according to claim 15, wherein the multi unit polymeric precursors and the single unit polymeric precursors are acrylates.

19. The method according to claim 15, wherein the multi unit polymeric precursors and the single unit polymeric precursors are urethane acrylates.

20. The method according to claim 15, wherein the first fluid does not have more than about 5% by weight based on total weight of the first fluid before coating of polymer.

21. The method according to claim 15, wherein the viscosity of the first fluid is not greater than about 5 centipoise.

22. A method of slide coating comprising:
providing a first fluid, wherein the first fluid comprises multi unit polymeric precursors, single unit polymeric precursors and one or more solvents;
flowing the first fluid down a first slide surface, the first slide surface being positioned adjacent a substrate;
moving the substrate past the first slide surface through use of a roll;
coating the substrate with the first fluid by flowing the first fluid from the first slide surface to the substrate to form a first coated layer;
drying at least a portion of the first fluid; and
curing the first coated layer.
